(19) United States
(12) Patent Application Publication
(10) Pub. No.: US 2011/0253234 A1
(43) Pub. Date: Oct. 20, 2011

(54) LIQUID SHEETING DEVICE

(75) Inventor: Donald Perry Smith, JR., San Ramon, CA (US)

(73) Assignee: Donald Perry Smith, JR., San Ramon, CA (US)

(21) Appl. No.: 12/761,410

(22) Filed: Apr. 16, 2010

(51) Int. Cl. E03B 5/00; B23P 11/00

(52) U.S. Cl. 137/565.01; 29/428

(57) ABSTRACT

A method, system and an apparatus of a liquid sheeting is disclosed. In one embodiment, an apparatus includes a channel to allow a flow of liquid. The channel includes a proximal end and a rear end. One or more ends of the channel may be coupled to a liquid source through a connector. In addition, the apparatus includes a liquid sheeting component inserted into the channel to allow the liquid into the channel through an outlet of the liquid sheeting component designed thereof. The apparatus also includes one or more caps coupled with the one or more ends of the channel. One or more caps coupled to the channel may include a liquid inlet.

### FIELD OF TECHNOLOGY

This disclosure relates generally to a technical field of mechanical devices and, in one embodiment, to a method, system and apparatus of a liquid sheeting device.

### BACKGROUND

A liquid dispensing apparatus for decorative purposes may be designed for dispensing liquid in a visually pleasing form as in fountains, and liquid theme parks. Visually pleasing uniform sheet obtained from the liquid dispensing apparatus may be used outdoors for decorative purposes. Such liquid dispensing apparatus may be used for some covered indoor applications because the apparatus can be sized to display many volumes of liquid. In addition, the apparatus may not have to be attached to large reservoirs for continuous supply of liquid because even at loss of liquid due to splashing or scattering, a splashguard can be used to or an auto fill system may be used for many sizes of containers. In addition, the liquid dispensing apparatus may be very inexpensive as it has three or more ways, to be installed indoors and outdoors. As a result, the decorative liquid dispensing apparatus may be used only in many environments such as areas shielded from wind or outdoors.

### SUMMARY

A method, system and an apparatus of a liquid sheeting device is disclosed. In one aspect, an apparatus includes a channel to allow a flow of liquid (e.g., water). The channel includes one or more ends. One or all the ends of the channel may be coupled to a liquid source through connectors. In addition, the apparatus includes a liquid sheeting component inserted into ‘n’ a horizontal plane of the channel to allow the liquid in the channel through an outlet of the liquid sheeting component provided thereof. The liquid sheeting component includes one or more sheeting materials structurally coupled to each other to form the outlet. The apparatus further includes one or more caps coupled to the one or more ends of the channel. One or more caps may include a liquid inlet. The channel may be any of, but not limited to a pipe, a conduit, and a duct.

In another aspect, a system includes a liquid sheeting apparatus that includes a channel and a liquid sheeting component coupled to the channel to generate a sheet of liquid. In addition, the system also includes a liquid source. The system may also include a pumping device to supply a continuous flow of liquid to the liquid sheeting apparatus through a connection. The connection may a pipe.

In yet another aspect, a method of manufacturing an apparatus includes forming an opening at a centre of a channel along a horizontal surface of the channel. The length of the opening in the channel being lesser than the horizontal length of the surface of the channel. In addition, the method includes forming a liquid sheeting component of length and width substantially equal to the opening of the channel, with an air gap at the center of the liquid sheeting component. The liquid sheeting component may be made of two or more pieces of a sheeting material. The sheeting material may be a plastic, metal or any suitable material. The method may also include coupling and securing the liquid sheeting component with the channel through the opening such that a predetermined part of liquid sheeting component is inserted into the channel while remaining part of the liquid sheeting component being kept external to the surface of the channel.

The method further includes coupling an inlet cap to any of a proximity end or a rear end of the channel and coupling a covering cap to the end not coupled by the inlet cap. The inlet cap as described herein includes an inlet located on one side of the inlet cap to enable a flow of liquid into the channel.

In addition, the method may include selecting two or more pieces of the sheeting material to form the liquid sheeting component. One of the sheeting component pieces of the pieces of the sheeting material has a length larger than the length of the other pieces. The method may include adjusting the inlet cap such the inlet is towards the side of the longer piece of material of the liquid sheeting component in the channel. The method may also include providing a route for liquid flow from a liquid source to the channel using a pipe through the inlet cap. The channel described herein may be any of, but not limited to a pipe, a conduit, and a duct.

Other aspects will be apparent from the following description and the appended claims.

### BRIEF DESCRIPTION OF THE VIEWS OF DRAWINGS

Example embodiments are illustrated by way of example and not limitation in the figures of accompanying drawings, in which like references indicate similar elements and in which:

FIG. 1 is a cross section view of a liquid sheeting apparatus, according to one or more embodiments.

FIG. 2 is a top view of a liquid guiding component of the liquid sheeting apparatus, according to one or more embodiments.

FIG. 3 is a cross sectional view of a liquid sheeting apparatus, according to an alternate embodiment.

FIG. 4 is an angled view of the liquid sheeting apparatus illustrating structural alignment of the separator unit on an external surface of the liquid sheeting apparatus, according to one or more embodiments.

FIG. 5 is a cross sectional view of the liquid sheeting apparatus illustrating a constructed structure, according to an example embodiment.

FIG. 6 is a schematic view of an inlet cap illustrating a positional alignment of an oblong hole inlet with respect to a centre line of the inlet cap, and an insertion of a pipe into the positioned oblong hole, according to an example embodiment.

FIG. 7 is a back view of the liquid sheeting apparatus, according to one or more embodiments.

FIG. 8 is a front view of liquid sheeting apparatus, illustrating the assembly of the channel with end caps, according to an example embodiment.

FIG. 9 is a system view illustrating the liquid sheeting apparatus coupling with a liquid source, according to an example embodiment.

FIG. 10 is a cross section view of the liquid sheeting apparatus illustrating a flow of liquid in the liquid sheeting apparatus, according to an example embodiment.

FIG. 11 is a front view of the channel, according to an example embodiment.

FIG. 12 is a front view of the separator assembly, according to an example embodiment.

FIG. 13 is a front view of the individual separator pieces, according to an example embodiment.

FIG. 14 is a side view of the assembled separator and also the front view along with the front view of the tapered end separator according to an example embodiment.

Other features of the present embodiments will be apparent from accompanying Drawings and from the Detailed Description that follows.

### DETAILED DESCRIPTION

A method and system of a liquid sheeting apparatus is disclosed. In the following description, for the purpose of explanation, numerous specific details are set forth in order to provide a thorough understanding of the various aspects. Water sheeting is used for decorative purposes in industrial and in residential areas. Water sheeting is a process used for regulating a flow of liquid to obtain a uniform sheet of liquid. In one or more embodiments, various apparatus and method may be used for obtaining a water sheet. However, in one or more embodiments, an apparatus and a method for generating a sheet of water is described herein.

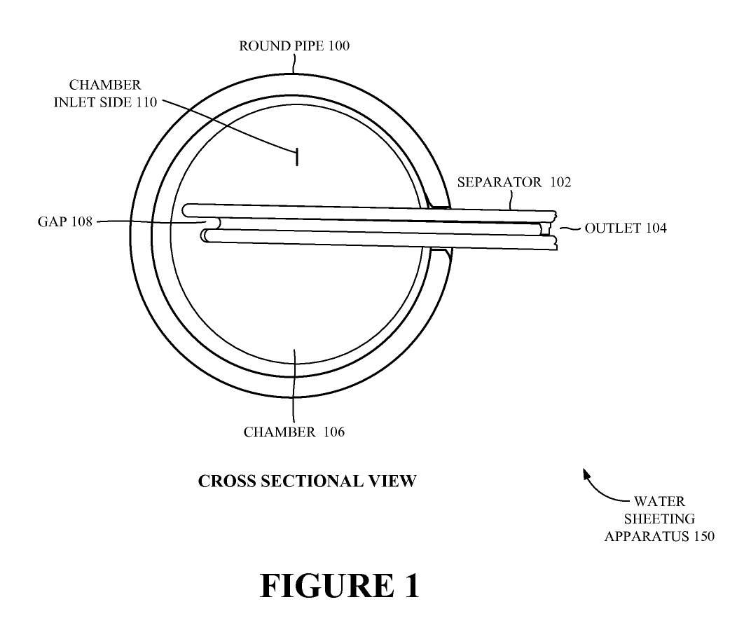

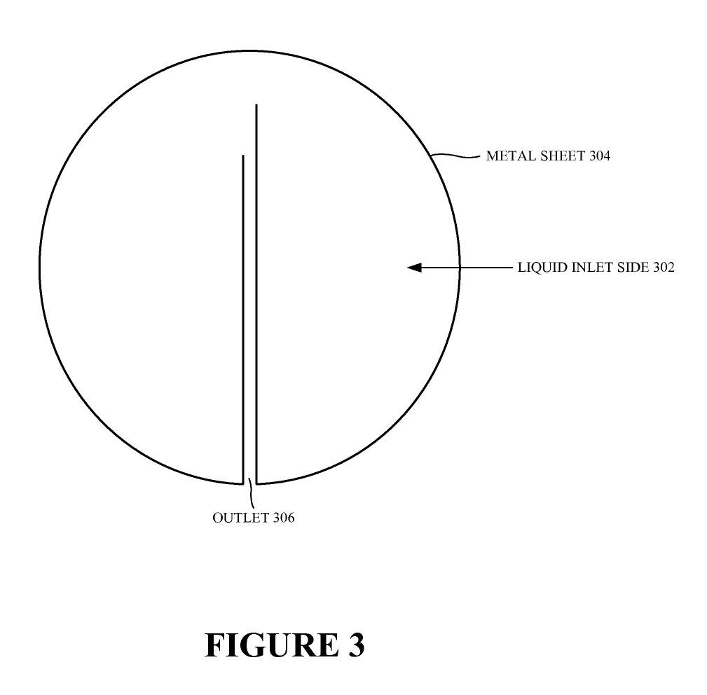

FIG. 1 is a cross section view of a liquid sheeting apparatus 150, according to one or more embodiments. The liquid sheeting apparatus 150 is used to obtain a uniform sheet of water. The water sheeting apparatus 150 includes a channel, a liquid sheeting component (e.g., a separator 102 as described herein) and caps covering the apparatus at ends. In one or more embodiments, the channel may be used for directing a flow of liquid. The channel may be a concrete cylindrical shaped pipe or a square shaped metal pipe used in the sheeting apparatus according to the requirements of applications. In an example embodiment, a Poly Vinyl Chloride (P.V.C) pipe 100 may be used as a channel to direct the flow of water. The separator 102 may be a component used to direct a flow of water from the channel to an outlet in the form of a uniform sheet. The separator 102 may be designed as the outlet 104 in the water sheeting apparatus 150. In one or more embodiments, the outlet 104 lip of the separator 102 can be lengthened or shortened as per the requirements of the application. The pipe 100 may be cut along the length to create a slot (e.g., an opening) for the separator 102. In one or more embodiments, the separator 102 may be made up of any material including, but not limited to a metal and plastic. The pipe 100 may be cut according to the requirements of the dimensions in order to fit the separator 102 in the pipe 100. However, in alternate embodiments, a metal sheet 304 may be used to design the liquid sheeting apparatus. The metal sheet may be bent and designed as the liquid sheeting apparatus to generate a thin sheet of liquid. Caps for the liquid sheeting apparatus may be designed accordingly as per design in the FIG. 3. FIG. 3 illustrates a cross section view of the water sheeting apparatus constructed using a metal sheet, according to an alternate embodiment. Furthermore, in another alternate embodiment, plastic may be user used for designing the liquid sheeting apparatus as illustrated in FIG. 3.

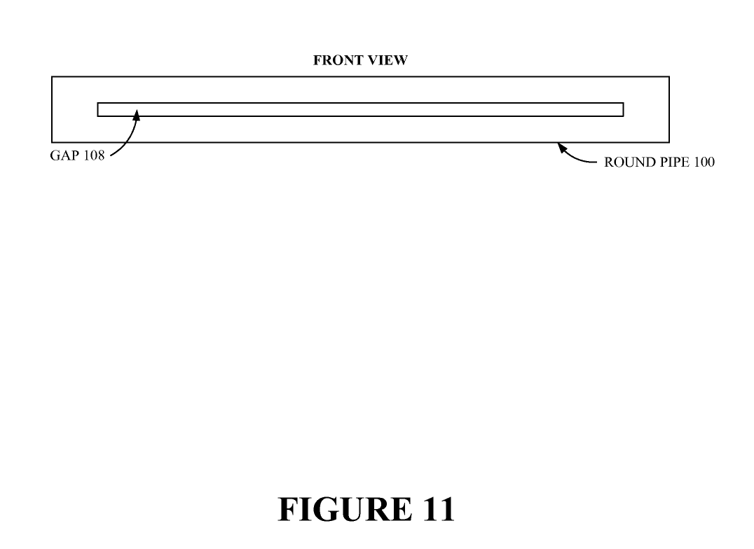

In the example embodiment, a round P.V.C pipe 100 with dimensions of 21 inch in length, having an outer diameter of 2.375 inch and an inner diameter of 2 inch is used as the channel. The P.V.C pipe is used as a channel in example embodiment because of light weight, portability and ease of use. Using a center as the reference of the pipe, an 18 inch line may be drawn along the length of the pipe leaving 1.5 inch on both the ends of the pipe. A slot measuring 18 inch in length and 0.25 inch to 0.281 inch wide may be cut over an aforementioned line along the length of the pipe using a router and a 0.25 inch straight bit tool (as illustrated in FIG. 11).

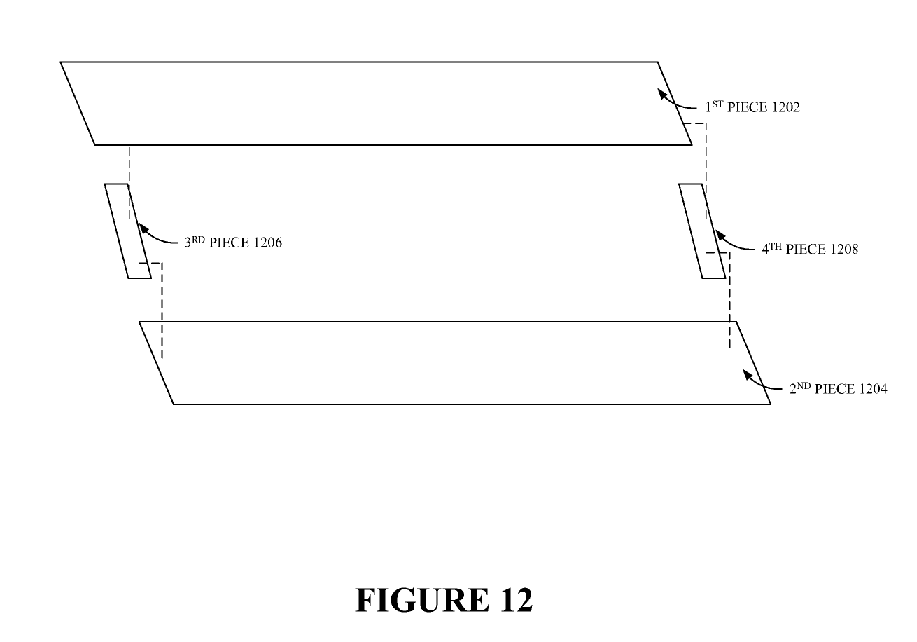

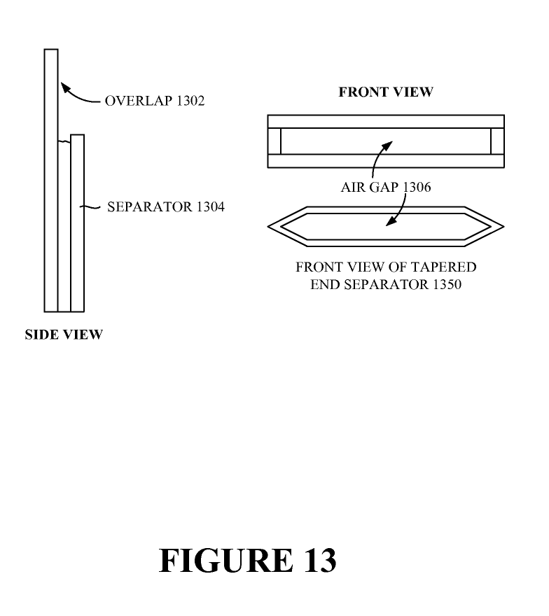

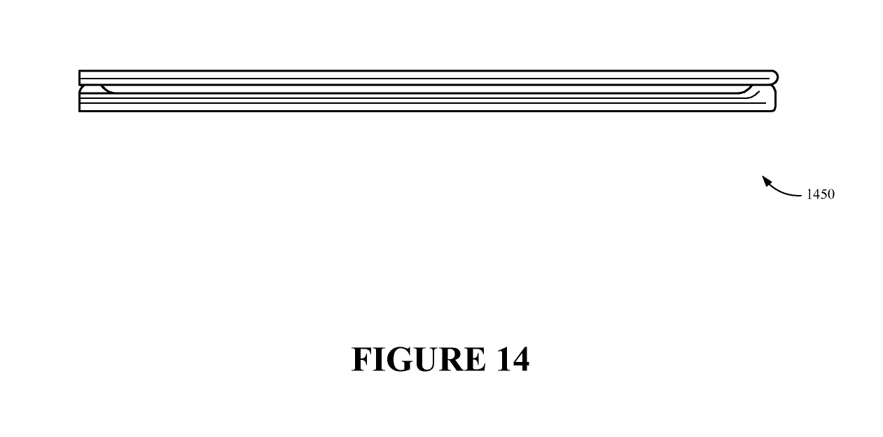

The separator 102 (e.g., a liquid sheeting component), as illustrated in the example embodiment, may be of plastic material. The plastic sheet of thickness 0.281 inch may be taken and four pieces of the required dimensions are cut namely, the first piece 1202 measuring 2.75 inch×18 inch, the second piece 1204 measuring 3 inch×18 inch and the third piece 1206 and the fourth 1208 pieces measuring 2.75 inch×0.125 inch may be cut (as illustrated in FIG. 12). These four cut pieces are coupled together by adhesion (as illustrated in 1450 of FIG. 14). The two pieces measuring 2.75 inch×0.125 inch are evenly secured along the top inside edge of the 2.75 inch×18 inch piece using a quick bond glue or through any suitable means. The third piece 1206 measuring 3 inch×18 inch is coupled to on the first piece 1202 with 2.75 inch×18 inch leaving a 0.25 inch overlap 1302 on one side and flush on the other. The first piece 102 may be secured to the second piece 1204 securing using quick bond glue. The offset or overlap may be reduced for faster air purging. If the offset in the separator 102 is too large, the apparatus may take several seconds to purge itself of air before producing a smooth sheet. This coupled separator component 1304 may have an air gap 1306 of 0.625 inch to 0.938 inch and a thickness of 0.25 inch to 0.281 inch. (As illustrated in FIG. 13). The separator 1304 may be designed in any preferred way based on a design required. FIG. 13 illustrates an example of a flat end separator and a tapered end separator 1350.

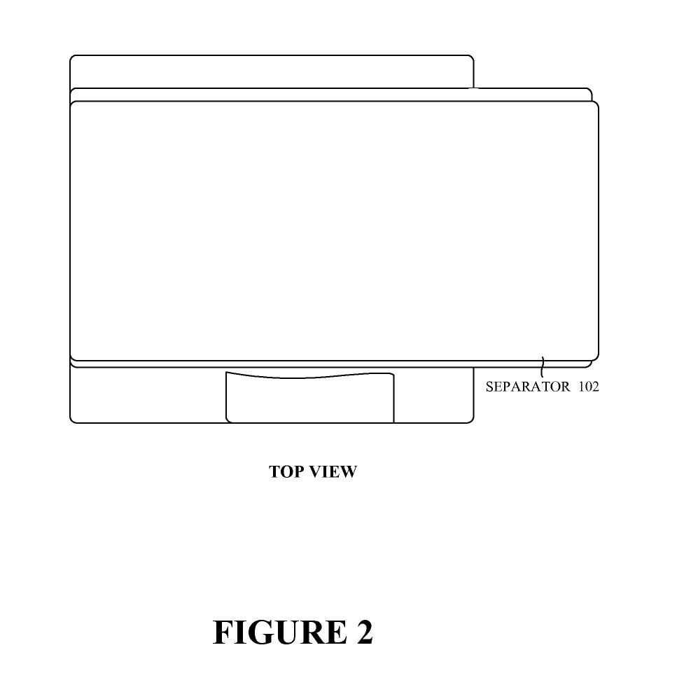

FIG. 2 is a top view of a liquid guiding component of the liquid sheeting apparatus, according to one or more embodiments. The liquid guiding component may be used to align the separator 102 component into the slot created in the pipe 100. The guiding component may be of any material and dimensions, according to the requirements of the applications.

In the example embodiment, the guiding component measuring 17.5 inch×4 inch may be cut from a plastic sheet. The guiding component may be inserted in the separator assembly from the front end. The guide may be positioned at 0.125 inch to 0.25 inch in the separator component as the guiding component passes the overlap in the separator 102.

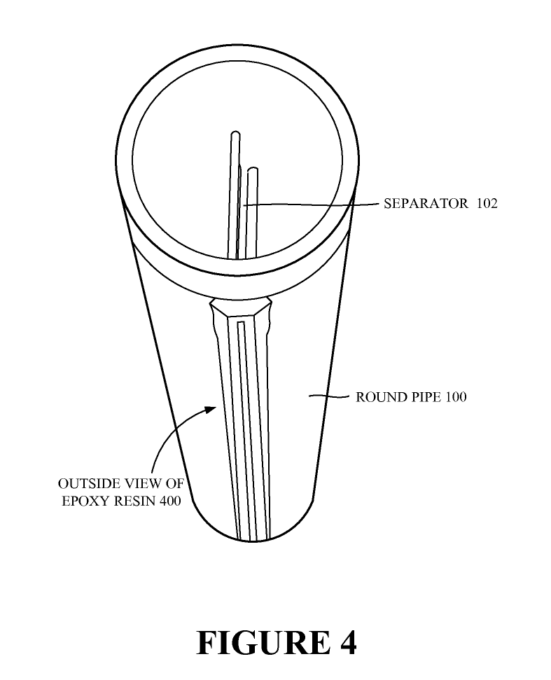

The separator 102 component along with the guiding component may be placed in the slot that was created in the P.V.C pipe 100. In the example embodiment, the coupled separator assembly along with the guiding component may be placed in the 0.25 inch gap of the 2 inch P.V.C pipe 100 without moving the guide. The guide bottoms out on the inside of the P.V.C pipe 100 ensuring the gap 502 between the inside of the P.V.C pipe 100 and the separator 102 may be 0.125 inch to 0.25 inch. In the example embodiment, epoxy resin 400 may be applied on coupling areas the P.V.C pipe 100 where the separator 102 and the P.V.C pipe 100 are aligned. In one or more embodiments, the epoxy resin may be applied at coupling areas internal to the pipe 100 and external to the pipe (e.g., as illustrated in FIG. 4).

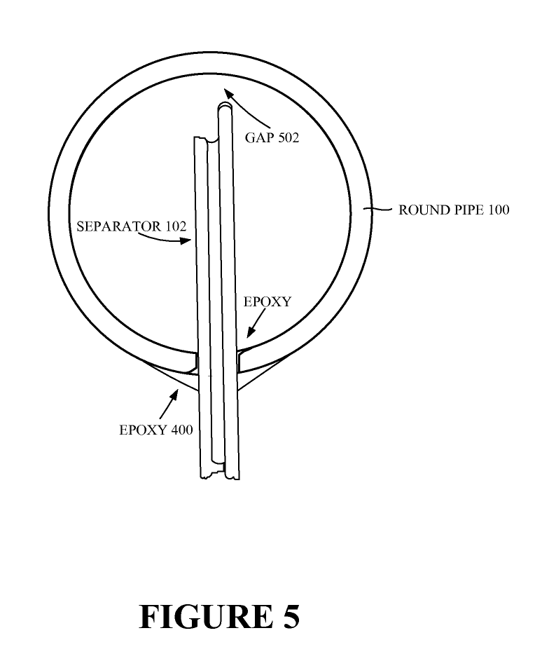

Epoxy resin 400 may used because of its high strength, dimensional stability and corrosion resistance, in addition to liquid proofing. The separator 102 is coupled to the inside of the P.V.C pipe 100 by applying the epoxy resin 400 into the P.V.C pipe 100. The epoxy resin 400 may be left to dry around the separator 102. When the epoxy resin 400 dries the separator 102 may have a watertight bond with the P.V.C pipe 100. The guide may be removed once the watertight bond is achieved between the separator 102 and the P.V.C pipe 100 (As illustrated in FIG. 4 and FIG. 5).

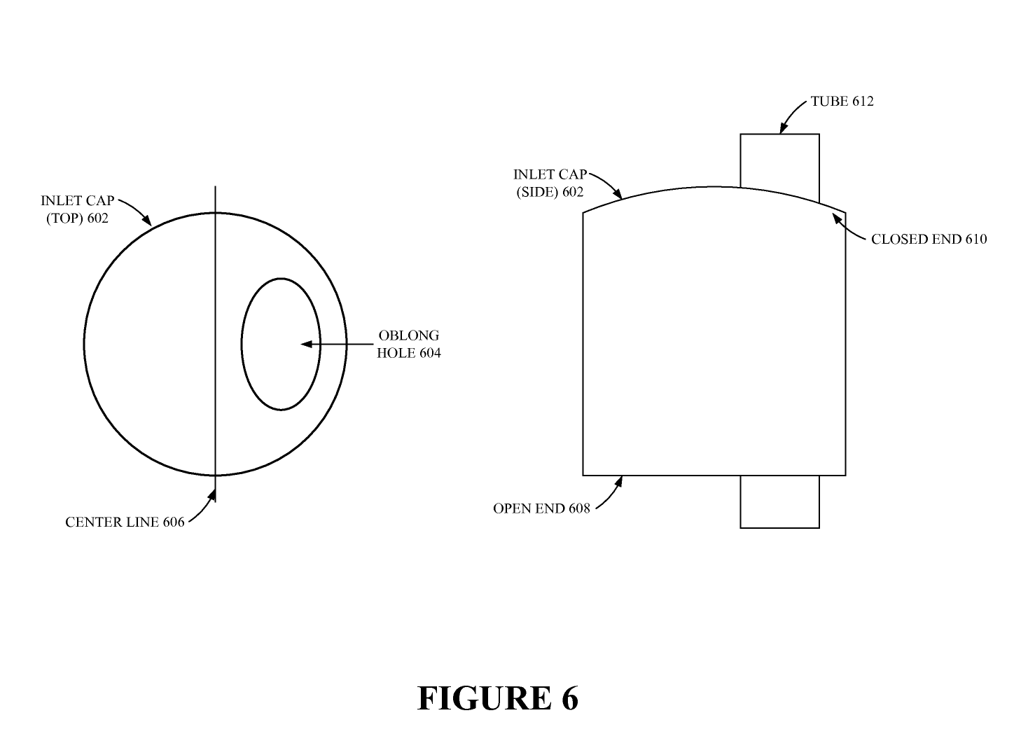

As described in FIG. 1, the inlet chamber may be provided with liquid through an inlet cap 602 (e.g., illustrated in FIG. 6). According to the example embodiment, the inlet cap 602 may be coupled to any of the either sides of the pipe 100. The inlet cap may be coupled to a rear end or to a proximity end of the pipe 100.

FIG. 6 is a schematic view of an inlet cap illustrating a positional alignment of an oblong hole 604 with respect to a centre line of the cap, and an insertion of a channel into the positioned oblong hole, according to an example embodiment. In the example embodiment, the inlet cap 602 is made from the 2 inch diameter P.V.C pipe. The oblong hole 604 may be created on one side of the cap, preferably away from the center line 606 of the cap towards one half of the cap. The dimensions of the oblong hole 604, according to the example embodiment, may be 1.5 inch long×1 inch wide. In alternate embodiments, any kind of opening may be formed, not limited to an oblong hole.

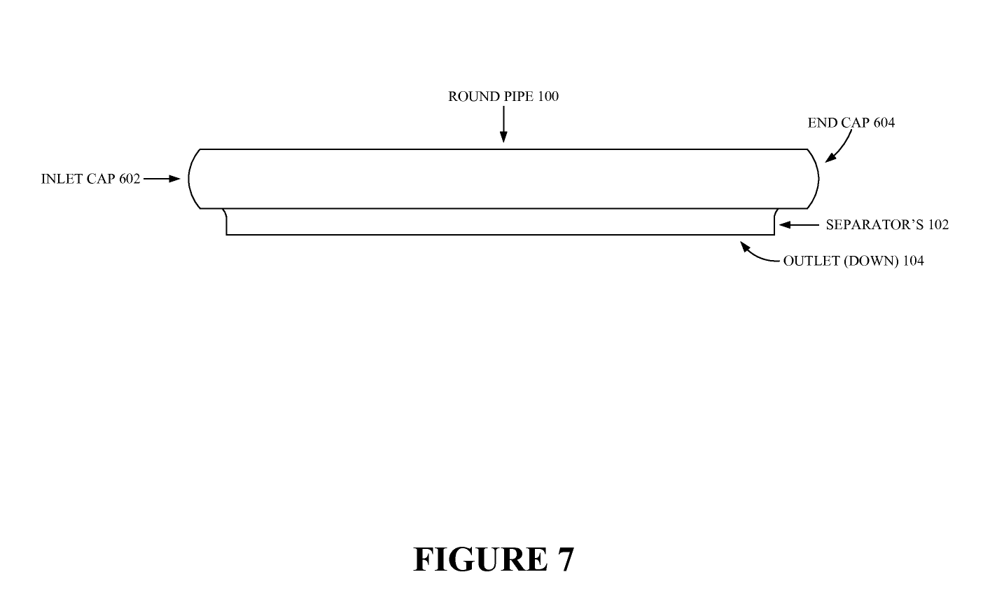

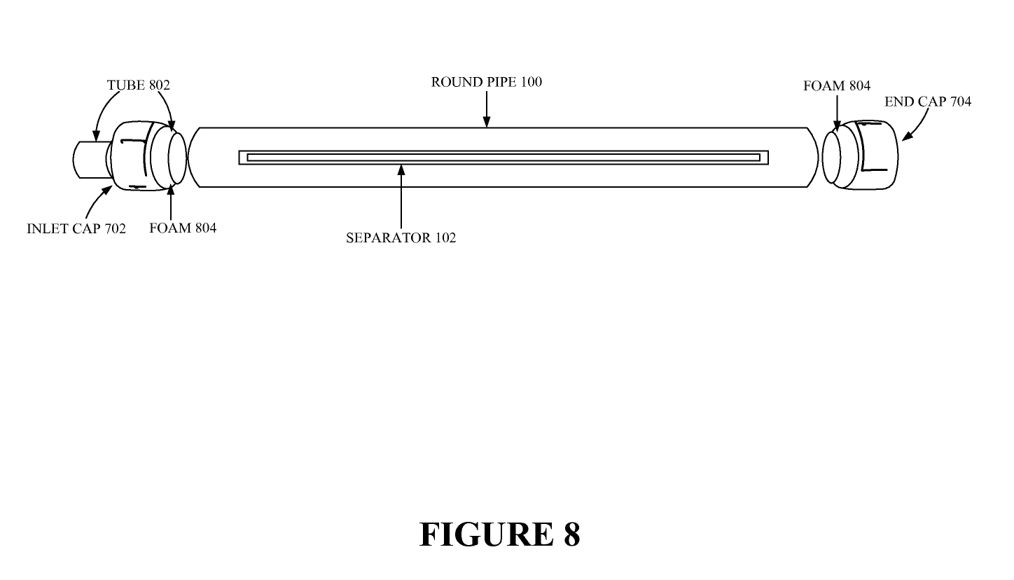

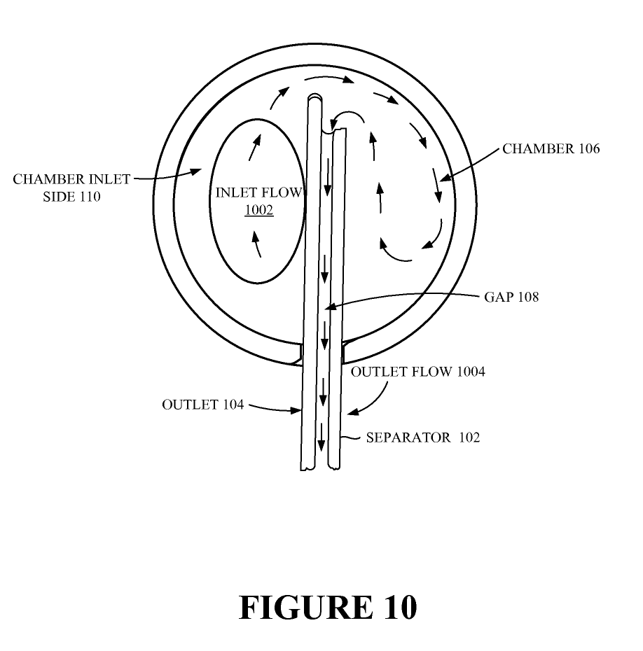

According to the example embodiment, a P.V.C tube 612 measuring 4 inch in length having an outer diameter 1.25 inch and with an inner diameter of 1 inch is cut. The tube 612 may be inserted into the oblong hole 604 cut on the inlet cap 602 such that 1.5 inch of the tube may be extending on closed end 610 of the inlet cap 602 and 0.5 inch past the other end 608 of the inlet cap 602. The 2 inch cap and the P.V.C tube are coupled using the epoxy resin to obtain a liquid tight seal. A piece of water proof foam 804 may be inserted into the inlet cap 602 and the end cap 704 ensuring 0.5 inch of the foam may be left out from the end cap 704 and the inlet cap 602 (as illustrated in FIG. 8). The foam provides a snug fit between the inside of the P.V.C pipe tube and the inlet cap 602. FIG. 7 is a back view of the liquid sheeting apparatus, according to one or more embodiments. The inlet side of the cap may be installed on the taller side of the separator 102 on the P.V.C pipe 100 (as illustrated in FIG. 10). The inlet cap may be positioned towards the taller side of the separator for the optimum working of the water sheeting apparatus 150. Introducing liquid into both the ends of the tall side of the separator may enable the apparatus to have extended lengths/widths or mixing capabilities. The blank 2 inch end cap may be installed on the other end of the 2 inch P.V.C pipe. A rubber mallet may be used to tap the caps to obtain snug liquid tight fit. For some applications zero gaps may be provided between the polyvinyl tube, foam and the separator when sealed.

FIG. 10 is a cross section view of the liquid sheeting apparatus illustrating a flow of liquid, according to an example embodiment. In the example embodiment, liquid enters the through the inlet cap of the apparatus into the inlet chamber side 110. The inlet flow 1002 of the liquid is directed to chamber 106 and from there the flow may be directed into the gap 108 of the separators 102 which produces the outlet flow 1004 of the liquid in the form of a uniform sheet at the outlet 104. In one or more embodiments, the length of the water sheet may be adjusted depending on the pressure of the liquid in the liquid sheeting apparatus 150.

In alternate embodiments, the water sheeting apparatus can be constructed using metals or plastic and the material may be bent to obtain the required configurations. Parts may be welded or soldered according to the requirements of the applications. The water sheeting apparatus may be configured to be large or small; the gaps of the separator 102 may be configured as per the application requirements. A filter may be used to trap debris at the inlet cap. For the optimum performance of the apparatus, the plumbing and the inlet inner diameter should be half the inner diameter of the pipe 100.

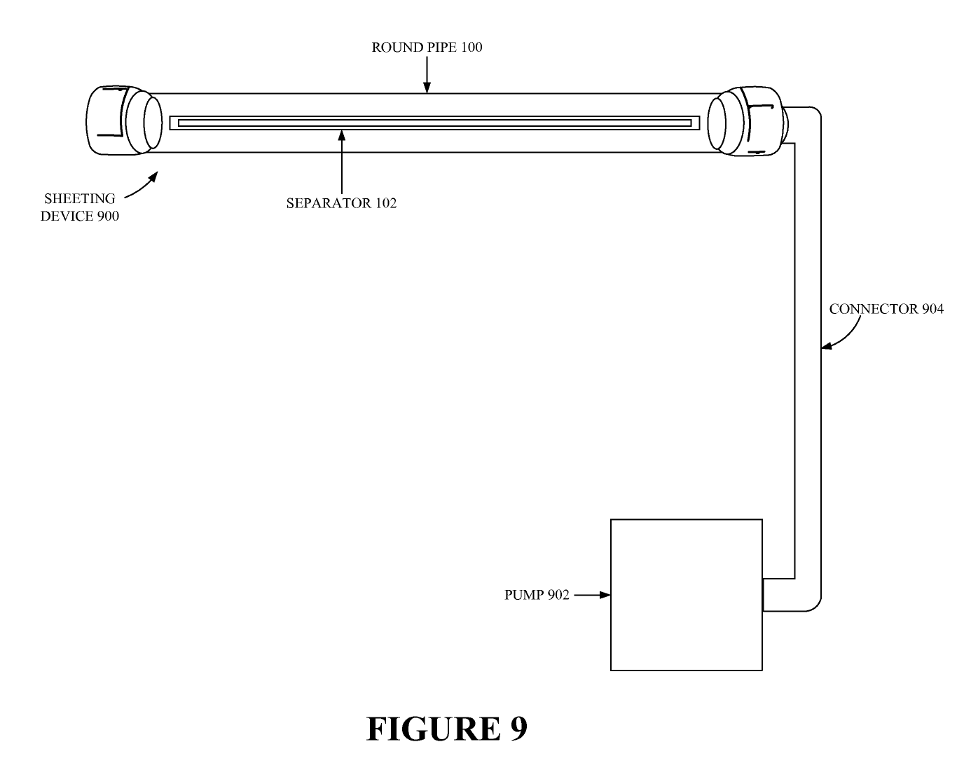

In the example embodiment, for a 2 inch inner diameter and 18 inch width liquid sheeting apparatus configuration, a 600 GPH submersible small pond pump with a 0.75 inch to 1 inch inner diameter, the outlet may produce the required pressure and volume needed for a 24 inch long and 17.75 inch wide at the top of the sheet tapering down to about 16 inch wide at the liquid level. The length of the sheet can be adjusted depending on the pressure and volume applied. Plumbing may be used to connect the liquid sheeting apparatus 150 to the pump 902 (e.g., pumping device). The connector 904 measuring 40 inch in length with 1 inch inner diameter may be used to connect the sheeting apparatus 900 with the pump 902. (As illustrated in FIG. 9).

Although the present embodiments have been described with reference to specific example embodiments, it will be evident that various modifications and changes may be made to these embodiments without departing from the broader spirit and scope of the various embodiments. Accordingly, the specification and drawings are to be regarded in an illustrative rather than a restrictive sense.

What is claimed is:

1. An apparatus comprising:
a channel to allow a flow of liquid, wherein the channel comprises at least one open end, wherein at least one of the end of the channel is coupled to a liquid source;
a liquid sheeting component inserted into the channel to allow the liquid in the channel through an outlet of the liquid sheeting component designed thereof, wherein the liquid sheeting component comprises at least two layers structurally coupled to each other to form the outlet; and
at least one of a cap coupled to the channel at least one of the ends, wherein at least one of the caps comprise a liquid inlet;

2. The apparatus of claim 1: wherein the channel is a pipe.

3. A system comprising:
a liquid sheeting apparatus comprising a channel and a liquid sheeting component coupled to the channel to generate a sheet of liquid;
a liquid source; and
a pumping device to supply a continuous flow of liquid to the liquid sheeting apparatus through a connection.

4. A method of manufacturing a liquid sheeting apparatus comprising:
forming an opening at a centre of a channel along a horizontal surface of the channel, length of the opening being lesser than the horizontal length of the surface of the channel;
forming a liquid sheeting component of length and width substantially equal to the opening of the channel, with an air gap at the center of the liquid sheeting component, wherein the liquid sheeting component is comprised of at least two pieces of a sheeting material;
coupling and securing the liquid sheeting component with the channel through the opening such that a predetermined part of liquid sheeting component is inserted into the channel while remaining part of the liquid sheeting component being kept external to the surface of the channel, wherein the at least one of piece of the pieces of material of the liquid sheeting component is longer than the other pieces; and
coupling an inlet cap to at least one end of the channel and coupling a covering cap to ends that are not coupled by the inlet cap, wherein the inlet cap to include an inlet located on one side of the inlet cap to enable a flow of liquid into the channel.

5. The method of claim 4 further comprising: selecting at least two pieces of the sheeting material to form the liquid sheeting component; wherein one of the piece of the pieces of the sheeting material is selected with a length larger than the length of the other pieces.

6. The method of claim 4 further comprising routing a liquid flow from a liquid source to the channel using a pipe through the inlet cap.

7. The method of claim 4: wherein the channel is at least one of a pipe, a conduit, and a duct.
